(19) United States
(12) Patent Application Publication
(10) Pub. No.: US 2006/0065355 A1
(43) Pub. Date: Mar. 30, 2006

(54) Waste removal laminate layering rapid prototyping machine

(76) Inventors: Yun-Yao Chiu, Taipei County (TW); Yunn-Shiuan Liao, Taipei City (TW); Hsin-Chih Li, Miaoli County (TW)

Correspondence Address: Yun-Yao CHIU & Joint Applicants, P. O. Box No. 6-57, Junghe, Taipei 235, TW

(21) Appl. No.: 10/952,872

(22) Filed: Sep. 30, 2004

(51) Int. Cl. B32B 37/00

(52) U.S. Cl. 156/247; 156/267; 156/272.8; 156/510

(57) ABSTRACT

A waste removal laminate layering rapid prototyping machine that embodies mold-releasing paper positioned atop a platform, and a press unit press that binds the mold-releasing paper onto a previous layer of the mold-releasing paper. A protective membrane is torn away from a topmost layer of the mold-releasing paper, whereupon a slicing unit cuts the topmost layer of the mold-releasing paper after having the protective membrane torn away into a preset shape, thereafter the protective membrane is returned, and is press bound atop the topmost layer of the mold-releasing paper, thereby allowing the waste material to adhere to the protective membrane. An adhesive failure unit causes interior waste material of the topmost layer of the mold-releasing paper to lose adhesiveness, thereby disabling from adhering to the previous layer of the mold-releasing paper. By repeating the aforementioned step, manufacturing of products provided with internally complex shapes is achieved.

### BACKGROUND OF THE INVENTION

(a) Field of the Invention

The present invention relates to a waste removal laminate layering rapid prototyping machine, and more particularly to a device that employs layering rapid prototyping technology to manufacture internally complex shaped products, and which is constructed to comprise a material collector/feeder unit, a waste material recycling unit, a press unit, a slicing unit, an adhesive failure unit and a platform structure.

(b) Description of the Prior Art

General rapid prototyping technology, also called material incress manufacturing or layer manufacturing technology differs from traditional material removal processing methods including lathes, milling machines, grinding sanding machines, planing machine, and so on. Because manufacturing method of the rapid prototyping technology embodies a processing method whereby material is added layer by layer.

Principle of the so-called rapid prototyping system involves cross-sectioning a three dimensional geometric figure from computer aided design software (CAD software) data into a multitude of layers of two dimensional planes, and result of the cross-sectioning is a stack of two dimensional geometrical data, with each layer representing a cross-section of a three dimensional figure, then thereupon a computer extracts a bottommost layer of the geometric figure and utilizes such for computer positioning control, whereupon an energy source and raw material are transferred to a working surface of each layer, and the raw material is added to a position indicated by the geometric figure.

According to the aforementioned procedure, the raw material is gradually added layer by layer from the bottommost layer to a topmost layer and bonded together. Upon completion, the three-dimensional prototype produced can thus be extracted.

In theory, during process of layering of the two-dimensional laminates and while still of a substantially thin nature, the three-dimensional prototype and the three-dimensional geometric figure created by the computer will look exactly alike, whereas during actual manufacture, method adopted for layering or stacking the laminate material is such that after stacking the laminates, various kinds of energy slicing or shaping are controlled through the computer program to thereby form a product having three-dimensional structure, and a cross section presents a staircase-like form.

The material utilized by the rapid prototyping is of three kinds, namely powder, liquid resin, and solid material, each of which possess different characteristics and areas of application.

With regard to technologies employing the powder material, Selective Laser Sintering and 3D printing as developed by Massachusetts Institute of Technology is utilized by DTM Company in the USA, and EOS/P and EOS/M series as developed by EOS company in Germany utilize the powder material. Powder manufacturing process is currently looked upon as the technology with most potential because of ability to directly manufacture metallic components, and utilizing this characteristic enables application to rapid tooling, which actualizes mass production of products with large turnover, and thus realizes extending field of application of rapid prototyping.

Currently, greatest number of manufacturers involved in rapid prototyping technology have invested in utilization of liquid resin as material source, and which also occupies largest market share. Technology employed can be divided into two categories, namely liquid photopolymer technology and nozzle technology. Relatively well-known manufacturers utilizing the liquid photopolymer technology include SLA of 3D Systems Company in the USA, Solid Ground Curing of Cubital company in Israeli, and SOUP (Solid Object Ultra-Violet Laser Printer) of CMET Company in Japan. Manufacturers utilizing the nozzle technology include FDM (Fused Deposition Manufacturing) of Stratasys Company in the USA, BPM (Ballistic Particle Manufacturing) of Perception Systems Company in the USA.

Relatively well-known manufacturers employing technologies that utilize solid material for shaping of components include Helisys Company in the USA employing LOM (Laminated Object Manufacturing) technology, and KIRA Company in Japan employing SAHP (Selective Adhesive and Hot Press) technology. From the aforementioned can be seen extensive development by current developed countries worldwide of what has been called CNC (Computerized Numerical Control) machines of the 21st century.

Because the LOM technology of the Helisys Company in the USA and the SAHP technology of the KIRA Company in Japan sizes a reverse side of the laminate material, and after stacking and then slicing an increased degree of difficulty in post-processing results. Hence, with the LOM technology adopting a method whereby the reverse side of the laminate material is sized, and thereafter proceeds with layering forming a square block therefrom, difficulty in removal of excessive material results. Whereas, because of problem of diffusion in the SAHP technology, which results in range of adhesive effect being substantially larger than anticipated, necessity for extreme caution in removal of the excessive material is thus required, otherwise machine components formed are easily damaged.

According to comparison and description of aforementioned products from various manufacturers, an understanding of the many still existent shortcomings of current rapid prototyping machines can be realized. In light of foresaid shortcomings in conventional structures, the inventor of the present invention has carried out extensive study and exploration to design a rapid prototyping machine that is capable of removing 30% to 80% waste material, reduces manufacturing time expended in working hours, and moreover, produces a product with superior outer form.

### SUMMARY OF THE INVENTION

In light of aforementioned shortcomings in conventional structures, the inventor of the present invention, having accumulated years of experience in related arts, attentively and circumspectively carried out extensive study and exploration to ultimately design a completely new waste removal laminate layering rapid prototyping machine.

A primary objective of the present invention is to provide the waste removal laminate layering rapid prototyping machine, which can be employed to manufacture internally complex shaped products.

In order to achieve the aforementioned objective, the waste removal laminate layering rapid prototyping machine of the present invention primarily embodies a material feeder unit that positions mold-releasing paper having an adhesive layer covered with a protective membrane atop a platform, and a press unit press that binds the mold-releasing paper onto a previous layer of the mold-releasing paper. The protective membrane of a topmost layer of the mold-releasing paper is torn away by means of a material collector unit, whereupon a slicing unit cuts the topmost layer of the mold-releasing paper after having the protective membrane torn away into a preset shape, thereafter interior and exterior waste material is finely cut into a plurality of small pieces, whereupon a waste recycling unit returns the protective membrane and effectuates press binding of the protective membrane atop the topmost layer of the mold-releasing paper, thereby allowing the waste material to adhere to the protective membrane, and thus achieving objective of recycling of the waste material. The protective membrane is then torn away again, and an adhesive failure unit causes a peripheral portion of a non-preset shape of the topmost layer of the mold-releasing paper to lose adhesiveness, thereby disabling the interior and exterior waste material from adhering to the previous layer of the mold-releasing paper, and the aforementioned step is repeated, thus realizing manufacture of products provided with internally complex shapes.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a manufacturing flow chart according to the present invention.

FIG. 2 shows an elevational schematic view according to the present invention.

FIG. 3 shows a schematic view of a material feeding step according to the present invention.

FIG. 4 shows a schematic view of a platform ascent step according to the present invention.

FIG. 5 shows a schematic view of press binding and first tearing away of a membrane according to the present invention.

FIG. 6 shows a schematic view of a slicing step according to the present invention.

FIG. 7 shows a schematic view of a return membrane step according to the present invention.

FIG. 8 shows a schematic view of second tearing away of a membrane according to the present invention.

FIG. 9 shows a schematic view of an adhesive failure step according to the present invention.

FIG. 10 shows a schematic view of the platform descent step according to the present invention.

FIG. 11 shows a schematic view of a method for stacking of mold-releasing paper after undergoing slicing according to the present invention.

FIG. 12 shows a schematic view of another embodiment of a press unit according to the present invention.

### DETAILED DESCRIPTION OF THE PREFERRED EMBODIMENTS

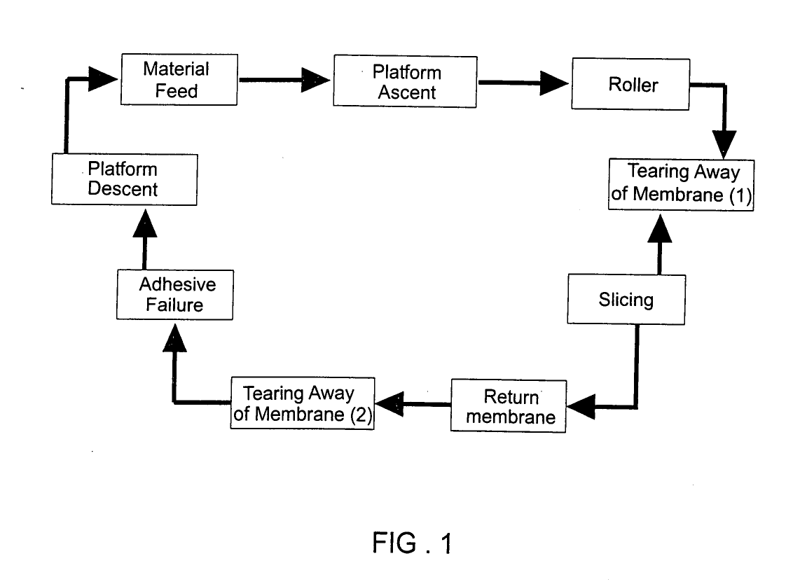

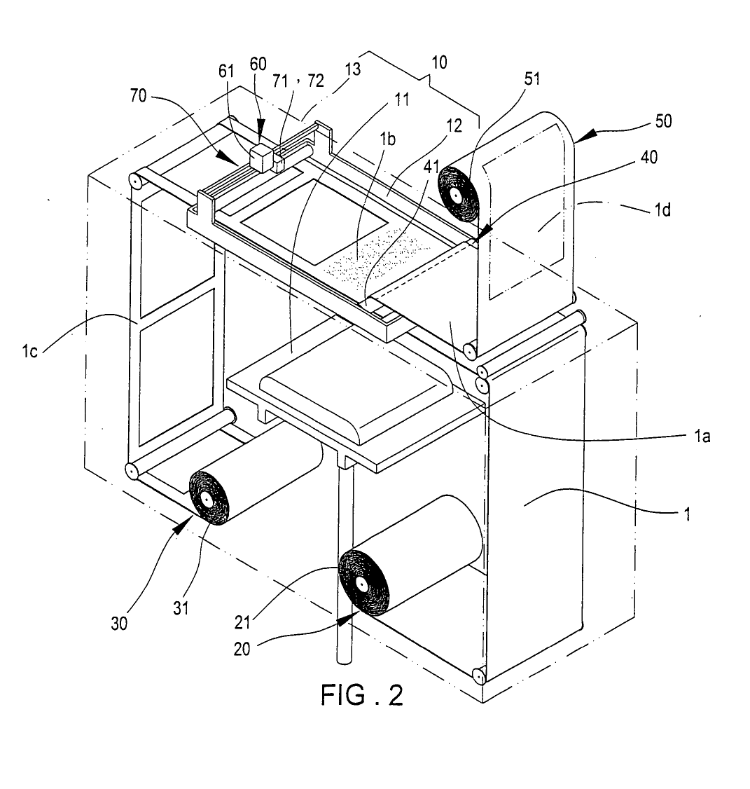

Referring to FIGS. 1 and 2, a waste removal laminate layering rapid prototyping machine of the present invention primarily embodies following steps described hereinafter:

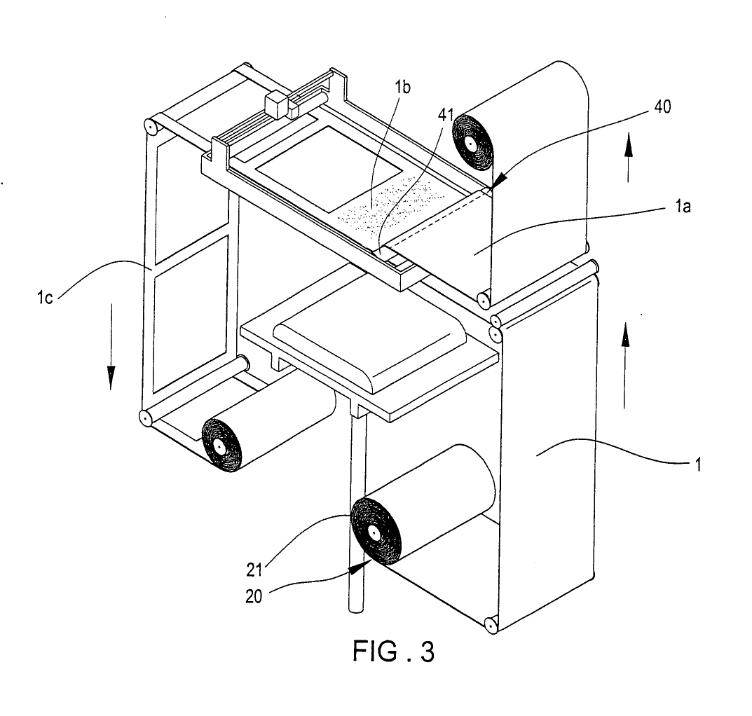

(a) Material feeding step: mold-releasing paper 1 provided with an adhesive layer 1b and covered with a protective membrane 1a is disposed on a material feeder roller 21 of a material feeder unit 20, and whereby a horizontal movement displacement roller 41 of a press unit 40 pulls an appropriate length to a work position, as depicted in FIG. 3.

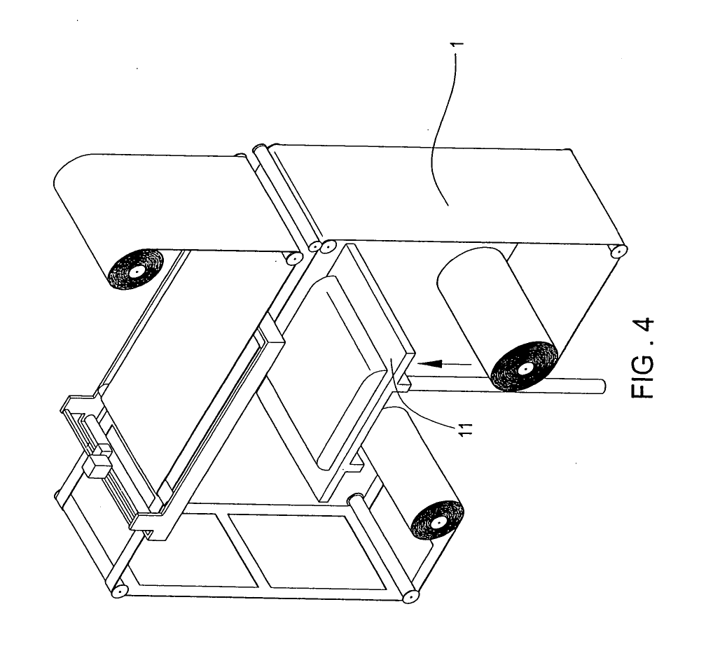

(b) Platform ascent step: a platform 11 is raised to the work position, thereby enabling the mold-releasing paper 1 to be positioned on the platform 11, as depicted in FIG. 4.

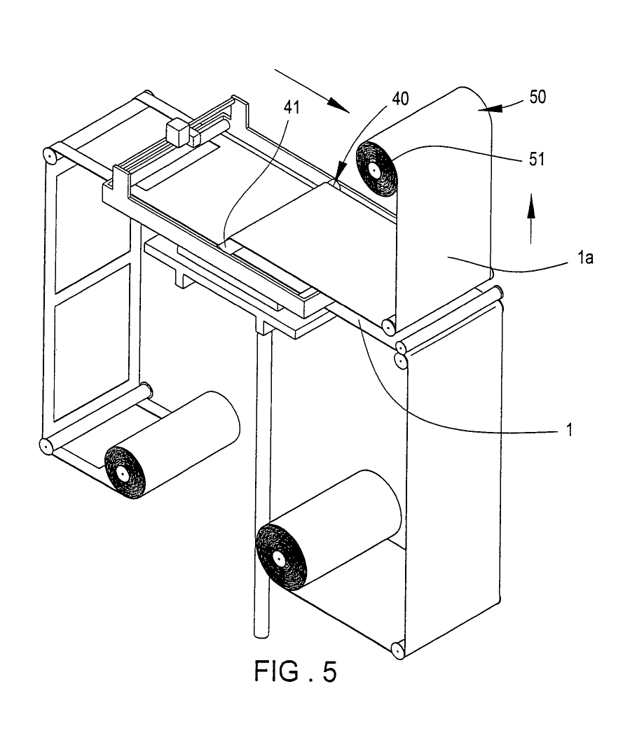

(c) Press binding step: the horizontal displacement roller 41 of the press unit 40 press binds the mold-releasing paper 1 onto a previous layer of the mold-releasing paper 1, thereby binding with the previous layer of the mold-releasing 1, as depicted in FIG. 5.

(d) Tearing away of first protective membrane step: upon the horizontal displacement roller 41 of the press unit 40 being set in motion, a membrane collector roller 51 of a waste material recycling unit 50 simultaneously tears away the protective membrane 1a of a topmost layer of the mold-releasing paper 1, as depicted in FIG. 5.

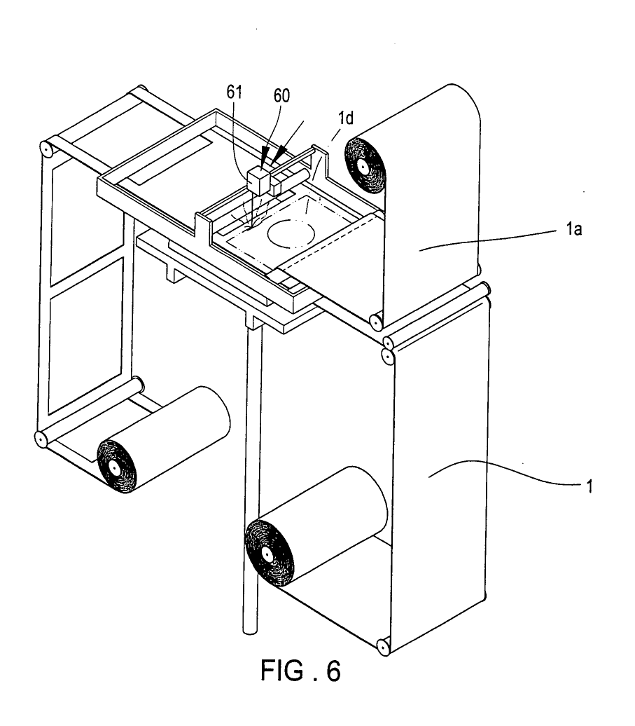

(e) Slicing step: a high energy optical cutting tool 61 configured interior of a slicing unit 60 slices the mold-releasing paper 1 having already removed the topmost protective membrane 1a into a preset shape, moreover, interior and exterior waste material 1d is finely cut up into a plurality of small pieces, as depicted in FIG. 6.

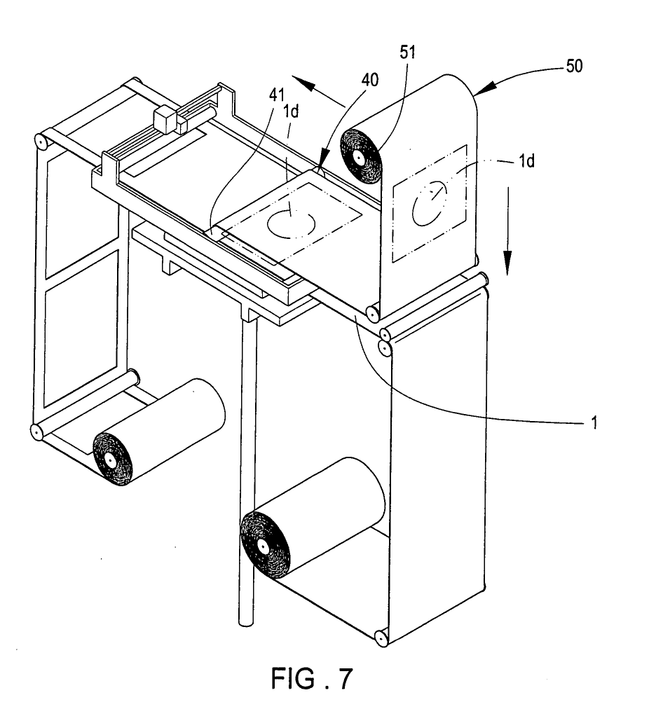

(f) Return membrane step: the horizontal displacement roller 41 of the press unit 40 pulls out the protective membrane la from the membrane collector roller 51 of the waste material recycling unit 50, thereby enabling re-pressing of the protective membrane 1a onto the mold-releasing paper 1 thereof, and thus allowing binding together with the cut-up interior waste material 1 d of the mold-releasing paper 1, as depicted in FIG. 7.

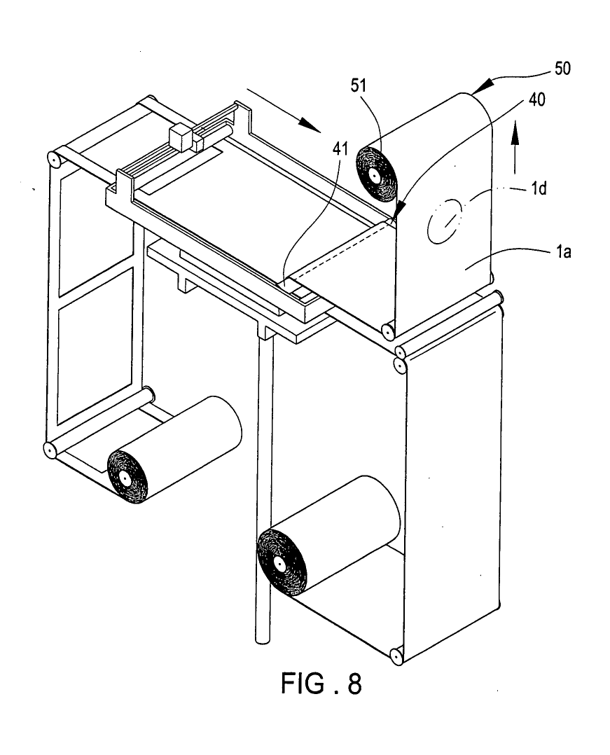

(g) Tearing away of second protective membrane step: upon the horizontal displacement roller 41 of the press unit 40 being set in motion, the membrane collector roller 51 of the waste material recycling unit 50 simultaneously retrieves the protective membrane 1a after being bound with the waste material 1d, as depicted in FIG. 8.

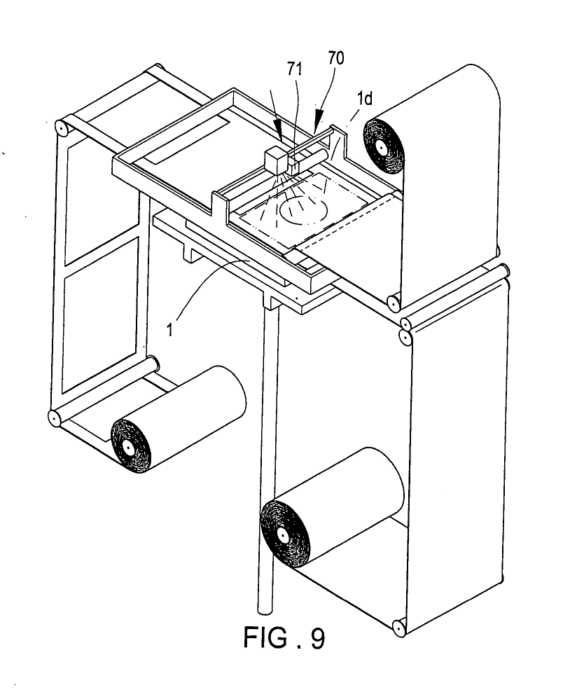

(h) Adhesive failure step: a peripheral portion of a non-preset shape of the topmost layer of the mold-releasing paper 1 is allowed to lose adhesiveness by means of an adhesive failure unit 70, as depicted in FIG. 9, thereby disabling the interior and the exterior waste material 1d from adhering to the topmost layer of the mold-releasing paper 1, and thus gradually layering and forming required shape, as depicted in FIG. 9.

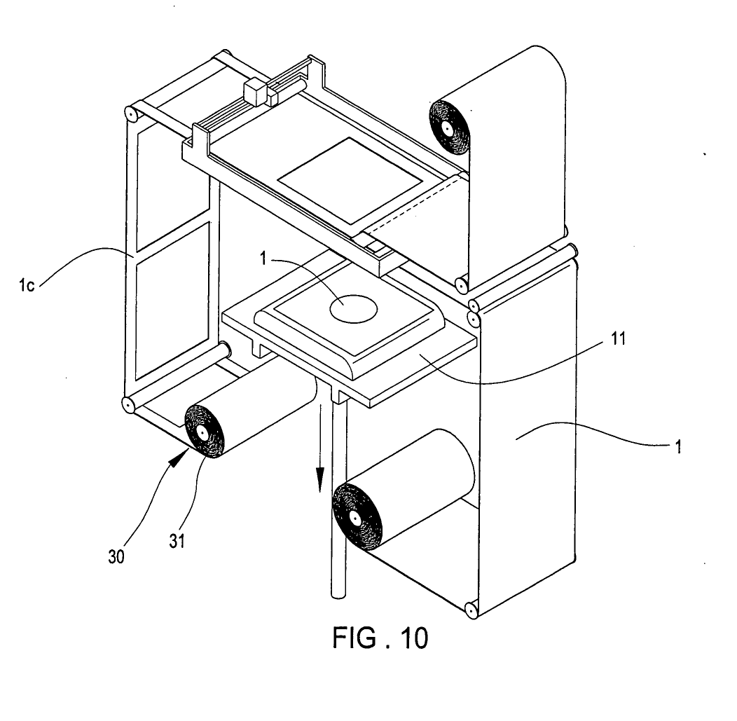

(i) Platform descent step: the platform 11 is lowered to original position, thereby enabling the mold-releasing paper 1 having undergone slicing to stack onto the previous topmost layer of the mold-releasing paper 1, and a material collector unit 30 retrieves excessive material 1c and transfers same to the material collector roller 31, as depicted in FIG. 10.

Devices described in the aforementioned manufacturing process are constructed to comprise component members as follows:

A platform structure 10, which is assembled to comprise the platform 11 configured to move in an upward and downward direction, a track support 12 configured to move horizontally, and a framework 13, wherein the bed platform 11 is employed to support and release the shape of the mold-releasing paper 1;

The material feeding unit 20, which is disposed on one side of the framework 13, and is provided with the material feeder roller 21 configured to hold non-processed mold-releasing paper 1;

The material collector unit 30, which is disposed on another side of the framework 13, and is provided with the material collector roller 31 that provides for rewinding the excessive material 1c of the mold-releasing paper 1 after slicing of same;

The press unit 40, which is disposed atop the track support 12, and along with the horizontal displacement roller 41, can move along the same track support 12 in material feeding direction, and moreover, the press unit 40 press binds the mold-releasing paper 1 to the previous layer of the mold-releasing paper 1;

The waste material recycling unit 50, which is disposed on one side above the framework 13, and is provided with the membrane collector roller 51 that rewinds the protective membrane la having been torn away, and is further utilized to retrieve the interior waste material 1d that has undergone slicing;

The slicing unit 60, which is disposed directly atop the track support 12, and that primarily employs the optical cutting tool 61 utilizing a high-energy laser to cut out the shape for each layer of the mold-releasing paper 1;

The adhesive failure unit 70, which is disposed at a side of the slicing unit 60, and that enables the peripheral portion of the non-preset shape to lose adhesiveness by means of a relatively low-energy optical cutting tool 71 or with an ink-jet nozzle 72 spraying carbon powder, thereby disabling the interior and exterior waste material 1d from adhering to the previous layer of the mold-releasing paper 1.

According to the aforementioned manufacturing method and devices, a product is horizontally sliced into a plurality of layers by means of the computer aided design (CAD), which then computes the shape of each layer to provide for proceeding with the follow-up slicing step of the slicing unit 60.

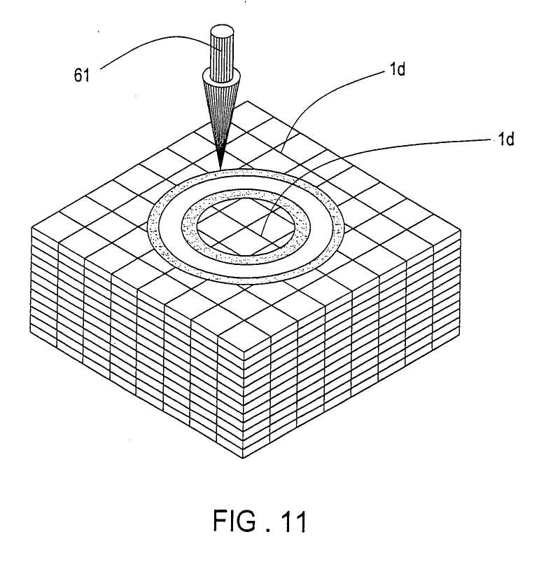

Referring to FIG. 2, after completing pre-operations, the first step implemented is that of adding the layer, whereby the material feeder roller 21 releases the rolled up mold-releasing paper 1, and the material collector roller 31 of another end rewinds the excessive material 1c. A computer program controls the material feeder roller 21 and the material collector roller 31 to move the mold-releasing paper 1 atop the platform 11. Immediately thereafter, the horizontal displacement roller 41 presses the mold-releasing paper 1 close to the platform 11, whereupon the horizontal displacement roller 41 draws back. The protective membrane 1a atop the mold-releasing paper 1 is torn away by means of the membrane collecting roller 51 of the waste material recycling unit 50, thereby revealing the adhesive layer 1b of the mold-releasing paper 1. Thereafter, the platform 11 moves downwards and the slicing step proceeds, whereby the high energy optical cutting tool 61 proceeds with slicing of the topmost layer of the mold-releasing paper 1 in accordance with slicing lines of the shape of each layer as previously computed by the computer aided design (CAD) program, which enables separation of the desired preset shape to be retained from the interior and exterior waste material 1d, whereafter, in accordance with rectangular slicing lines the interior and external waste material 1d are finely cut up into the plurality of small pieces, thereby facilitating removal of the interior and exterior waste material 1d, as depicted in FIG. 11.

Thereafter, the peripheral portion of the non-preset shape of the topmost layer of the mold-releasing paper 1 loses adhesiveness by means of the adhesive failure unit 70, thereby disabling the desired preset shape to be retained and the interior and exterior waste material 1d from adhering to the previous layer of the mold-releasing paper 1, moreover, upon stacking each layer of the mold-releasing paper 1, the interior waste material 1d positioned in the preset shape during process of stacking and shape forming is bound and retrieved by the protective membrane 1a by means of the waste material recycling unit 50, and upon completion of stacking and shape forming, the exterior waste material 1d is removed. Because of implementation of adhesive failure processing, thus, a semi-finished product formed from gradual layering is easily removed to obtain a product having complex interior shape.

The adhesive failure step employs technology including an out-of-focus laser beam or a laser beam of relatively low energy or the ink-jet nozzle spraying carbon powder, therewith enabling adhesive failure of overlapping regions of the preset shape and producing powder-like particles, which function as a release mechanism and prevents a binding effect from occurring.

Computation of the overlapping regions of the preset shape and the interior and exterior waste material 1d is based on parameters including laser diameter, thickness of laminate and gradient of machine component outline, and which are computed by employing a computer program.

Dimensions of the overlapping regions of the preset shape and the interior and exterior waste material 1d are key factors in influencing degree of difficulty of removal. When the overlapping regions are large, degree of difficulty in removing the interior and exterior waste material 1d increases, whereas, on the contrary, when the overlapping regions are small, removing the interior and exterior waste material 1d becomes relatively easier, therefore, variation in dimensions of the overlapping regions, the gradient of the outline of the preset shape and material thickness of the mold-releasing paper 1 are intimately related.

If when the gradient of the outline of the preset shape is relatively planar or close to being horizontal, then the overlapping regions are relatively large, whereas, when the gradient of the outline of the preset shape is steep or close to being perpendicular, then the overlapping regions are relatively small or no overlapping occurs at all. Hence, design of the outline of the machine components should as far as possible produce contours that are vertical or close to being vertical, thereby realizing objective of easy removal of the interior and exterior waste material 1d.

In other words, when the gradient of the outline of the preset shape of the machine component is relatively large, because the interior and exterior waste material 1d and the overlapping regions of the preset shape are relatively small, upon the optical cutting tool 61 proceeding with slicing the adhesive is already excluded, and thus does not influence removal process of the waste material 1d, and implementation of intensive slicing is averted, whereas when the gradient of the outline of the preset shape is relatively small, the overlapping regions produced are relatively large, which result in difficulty in implementing removal of the interior and exterior waste material 1d, and thus a necessity for proceeding with intensive slicing so as to effectuate adhesive failure. Hence, decision on whether or not to implement the adhesive failure step with intensive slicing is based on aforementioned criteria.

The manufacturing method of the present invention implements procedural measures involving gradual addition of layers based on operation requirements and slicing in accordance with computer programmed control of the optical tool 61. After gradual stacking of the layers and slicing is completed, the excessive waste material 1d is removed, and thus the finished product is formed therefrom. The finished product is then utilized as a prototype or a model for production usage.

The mold-releasing paper 1 is provided with the adhesive layer 1b, and after the protective membrane 1 a is torn away by means of the membrane collector roller 51, the mold-releasing paper 1 is stacked layer by layer, thus avoiding problems and inconvenience of heating as employed in conventional technology, and moreover, provides a simplified configuration, which lowers manufacturing costs. Furthermore, the material utilized for the mold-releasing paper 1 can

be high-polymer laminate material, paper, wood, even metals, compound materials, and so on. The optical cutting tool 61 of the slicing step can be a laser beam, an UV light beam, an electronic beam, an optical fiber energy device, and so on, all of which are capable of achieving identical efficacy by means of programmable computer control, only limitation being in the slicing of the mold-releasing paper 1, which requires employment of the laser beam or other energy devices.

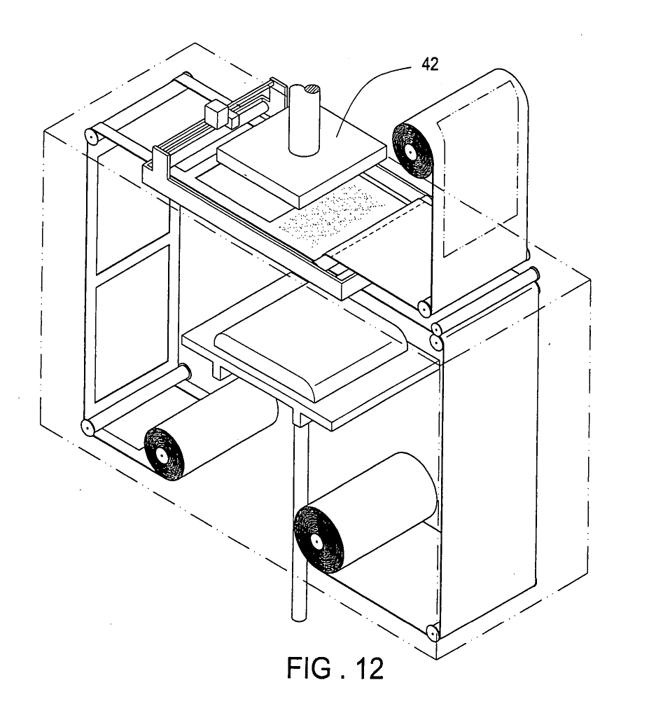

In addition, left and right moving of the horizontal displacement roller 41 along with the press unit 40 or upward and downward moving of a press block 42, as depicted in FIG. 12, similarly achieves objective of pressing, and which is another embodiment of the present invention.

The waste material recycling unit 50 acts as a vacuum attractor 52, whereby the excessive interior waste material 1d remaining after slicing is eliminated by means of an attractive force of a vacuum, and which is yet another embodiment of the present invention.

In conclusion, the manufacturing method as disclosed in the present invention provides what prior art lacks, and assuredly achieves the aforementioned effectiveness efficacies benefits, and conforms with essential conditions of a patent application for a new invention. According, an application for a new patent is proposed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A selective waste removal laminate layering rapid prototyping manufacturing method comprising following steps:
(a) material feeding step: mold-releasing paper provided with an adhesive layer and covered with a protective membrane is disposed on a material feeder roller of a material feeder unit, and whereby a horizontal movement displacement roller of a press unit pulls an appropriate length to a work position;
(b) platform ascent step: a platform is raised to the work position, thereby enabling the mold-releasing paper to be positioned on the platform;
(c) press binding step: the horizontal displacement roller of the press unit press binds the mold-releasing paper onto a previous layer of the mold-releasing paper, thereby binding with the previous layer of the mold-releasing;
(d) tearing away of first protective membrane step: upon the horizontal displacement roller of the press unit being set in motion, a membrane collector roller of a waste material recycling unit simultaneously tears away the protective membrane of a topmost layer of the mold-releasing paper;
(e) slicing step: a high energy optical cutting tool configured interior of a slicing unit slices the mold-releasing paper having already removed the topmost protective membrane into a preset shape, moreover, interior and exterior waste material is finely cut up into a plurality of small pieces;
(f) return membrane step: the horizontal displacement roller of the press unit pulls out the protective membrane from the membrane collector roller of the waste material recycling unit, thereby enabling re-pressing of the protective membrane onto the mold-releasing paper thereof, and thus allowing binding together with the cut-up interior waste material of the mold-releasing paper;
(g) tearing away of second protective membrane step: upon the horizontal displacement roller of the press unit being set in motion, the membrane collector roller of the waste material recycling unit simultaneously retrieves the protective membrane after being bound with the waste material;
(h) adhesive failure step: a peripheral portion of a non-preset shape of the topmost layer of the mold-releasing paper is allowed to lose adhesiveness by means of an adhesive failure unit, thereby disabling the interior and the exterior waste material from adhering to the topmost layer of the mold-releasing paper, and thus gradually layering and forming required shape;
(i) platform descent step: the platform is lowered to original position, thereby enabling the mold-releasing paper having undergone slicing to stack onto the previous topmost layer of the mold-releasing paper, and a material collector unit retrieves excessive material and transfers same to the material collector roller; after removing the excessive waste material a product provided with an internally complex shape is obtained.

2. A selective waste removal laminate layering rapid prototyping device comprising:
a platform structure, which is assembled to comprise the platform configured to move in an upward and downward direction, a track support configured to move horizontally, and a framework, wherein the bed platform is employed to support and release the shape of the mold-releasing paper;
the material feeding unit, which is disposed on one side of the framework, and is provided with the material feeder roller configured to hold non-processed mold-releasing paper;
the material collector unit, which is disposed on another side of the framework, and is provided with the material collector roller that provides for rewinding the excessive material of the mold-releasing paper after slicing of same;
the press unit, which is disposed atop the track support, and along with the horizontal displacement roller, can move along the same track support in material feeding direction, and moreover, the press unit press binds the mold-releasing paper to the previous layer of the mold-releasing paper;
the waste material recycling unit, which is disposed on one side above the framework, and is provided with the membrane collector roller that rewinds the protective membrane having been torn away, and is further utilized to retrieve the interior waste material that has undergone slicing;
the slicing unit, which is disposed directly atop the track support, and that primarily employs the optical cutting tool utilizing a high-energy laser to cut out the shape for each layer of the mold-releasing paper; the adhesive failure unit, which is disposed at a side of the slicing unit, and that enables the peripheral portion of the non-preset shape to lose adhesiveness by means of a relatively low-energy optical cutting tool or with an ink-jet nozzle spraying carbon powder, thereby disabling the interior and exterior waste material from adhering to the previous layer of the mold-releasing paper.

3. The selective waste removal laminate layering rapid prototyping device according to claim 2, wherein the optical cutting tool can be a laser beam, an UV light beam, an electronic beam, an optical fiber energy device, and so on, moreover, energy for effectuating adhesive failure can be from a laser beam, an UV light beam, an electronic beam, an optical fiber energy device, and so on.

4. The selective waste removal laminate layering rapid prototyping device according to claim 2, wherein the press unit is effectuated by means of upward and downward movement of a press block.

5. The selective waste removal laminate layering rapid prototyping device according to claim 2, wherein the waste material recycling is a vacuum attractor.
